(19) United States
(12) Patent Application Publication
(10) Pub. No.: US 2005/0134765 A1
(43) Pub. Date: Jun. 23, 2005

(54) Dual display panel

(75) Inventors: Liu-Cheng Lin, Hsinchu (TW); Kuang-Tao Sung, Taichung County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronis Corporation

(21) Appl. No.: 10/738,040

(22) Filed: Dec. 18, 2003

(51) Int. Cl. G02F 1/1335

(52) U.S. Cl. 349/113

(57) ABSTRACT

A display device that comprises a first viewing face allowing viewing of a first image on display from a first direction, a second viewing face allowing viewing of a second image on display from a second direction, a light source, a transparent substrate, a light guide plate receiving light provided by the light source, a surface of the light guide plate that transmits the light toward the first viewing face, and a plurality of reflective regions provided -over the transparent substrate that reflect the light transmitted from the surface toward the second viewing face.

### FIELD OF THE INVENTION

This invention relates in general to a display device and, more particularly, to a flat panel display device including a dual display panel.

### BACKGROUND OF THE INVENTION

Flat panel display devices are typically backlit by a backlight assembly or alternatively front-lit by a front-light assembly. The backlight or front-light assembly generally includes a lamp and a light guide plate to provide uniform illumination to a display panel of a display device. Electronic products which use flat panel display devices may include lap-top computers, televisions, digital watches, calculators, telephones and cellular phones.

Certain electronic products, for example, cellular phones, are designed with a shell-type outlook. An exemplary shell-type electronic product 10 in the art is shown in FIGS. 1A and 1B. Referring to FIG. 1A, electronic product 10 includes an operation member 12 and a display panel 14 foldable with respect to operation member 14. Operation member 12 allows a user 16 of electronic product 10 to enter information through, for example, a keyboard (not shown). Display panel 14 may include a main panel 14-2 and a sub-panel 144. Generally, main panel 14-2 serves to provide main display functions of electronic product 10, and sub-panel 14-4 serves to provide subsidiary display functions such as caller identity display or clock display. When display panel 14 is held at an unfolded position, user 16 views an image on display from main panel 14-2. On the other hand, referring to FIG. 1B, when display panel 14 is held at a folded position, user 16 views an image on display from sub-panel 144.

FIG. 2 is a cross-sectional view of an electronic product 20 in the art.

Electronic product 20 includes a main panel 22, a sub-panel 24, a backlit assembly 26 common to main panel 22 and sub-panel 24, and a frame 28. Main panel 22 and sub-panel 24 are generally independent of each other, and include individual driving circuits (not shown). Referring to FIG. 2, main panel 22 includes a first polarizer 22-2, a color filter 224, a transparent substrate 22-6 and a second polarizer 22-8.

Similarly, sub-panel 24 includes a first polarizer 24-2, a color filter 244, a transparent substrate 24-6, and a second polarizer 24-8. Backlight assembly 26 includes a light source 26-2, a light guide plate 264, a first optical film 26-6 associated with main panel 22, and a second optical film 26-8 associated with sub-panel 24. Each of first and second optical films 26-6 and 26-8 may further include a layer structure of a diffuser (not shown) and prism sheets (not shown). Since panels and driving circuits are individually and severally required in electronic product 20, manufacturing cost and overall product size disadvantageously increase as a result.

### SUMMARY OF THE INVENTION

Accordingly, the present invention is directed to a display device and a method of display that obviate one or more of the problems due to limitations and disadvantages of the related art.

To achieve these and other advantages, and in accordance with the purpose of the invention as embodied and broadly described, there is provided a display device that comprises a first viewing face allowing viewing of a first image on display from a first direction, a second viewing face allowing viewing of a second image on display from a second direction, a light source, a transparent substrate, a light guide plate receiving light provided by the light source, a surface of the light guide plate that transmits the light toward the first viewing face, and a plurality of reflective regions provided over the transparent substrate that reflect the light transmitted from the surface toward the second viewing face.

In one aspect, each of the reflective regions further comprises a metal electrode formed thereon.

In another aspect, the reflective regions are separated from each other by transmissive regions provided over the transparent substrate.

Also in accordance with the present invention, there is provided a display device that comprises at least one light source, a transparent substrate, a light guide plate receiving light provided by the at least one light source, a surface of the front light guide plate that transmits the light received from the light source toward the transparent substrate, a plurality of transmissive regions disposed between the light guide plate and the transparent substrate that allow the light to pass the transparent substrate, and a plurality of reflective regions disposed between the light guide plate and the transparent substrate that reflect the light toward the light guide plate.

In one aspect, the at least one light source further comprises a light emitting diode, a cold cathode ray tube and an ambient light.

Still in accordance with the present invention, there is provided a display device that comprises a single display panel including a first side and a second side, a transparent substrate formed in the single display panel, a transparent light guide plate receiving light provided by a light source, a surface of the light guide plate that transmits the light from the light source toward the single display panel, a plurality of transmissive regions disposed between the transparent light guide plate and the transparent substrate that allow the light to pass the first side of the display panel, and a plurality of reflective regions separated from each other by the transmission regions that reflect the light toward the second side of the display panel.

Yet still in accordance with the present invention, there is provided a method of displaying an image that comprises providing a single display panel with a first side and a second side, providing a transparent substrate disposed between the first and second sides, providing light from a light source, providing a transparent light guide plate receiving the light provided by the light source, providing the transparent light guide plate with a surface, transmitting the light via the surface toward the display panel, providing a plurality of transmissive regions disposed between the transparent light guide plate and the transparent substrate, providing a plurality of reflective regions disposed between the transparent light guide plate and the transparent substrate, passing the light transmitted from the surface through the transmissive regions through the first side of the display panel, and reflecting the light transmitted from the surface by the reflective regions toward the second side of the display panel.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIGS. 1A and 1B are schematic diagrams of an electronic product in the art;

FIG. 2 is a cross-sectional view of an electronic product in the art;

FIG. 3 is a cross-sectional view of a display device in accordance with one embodiment of the present invention; and

FIGS. 4A and 4B are diagrams illustrating the operation of a display device in accordance with one embodiment of the present invention.

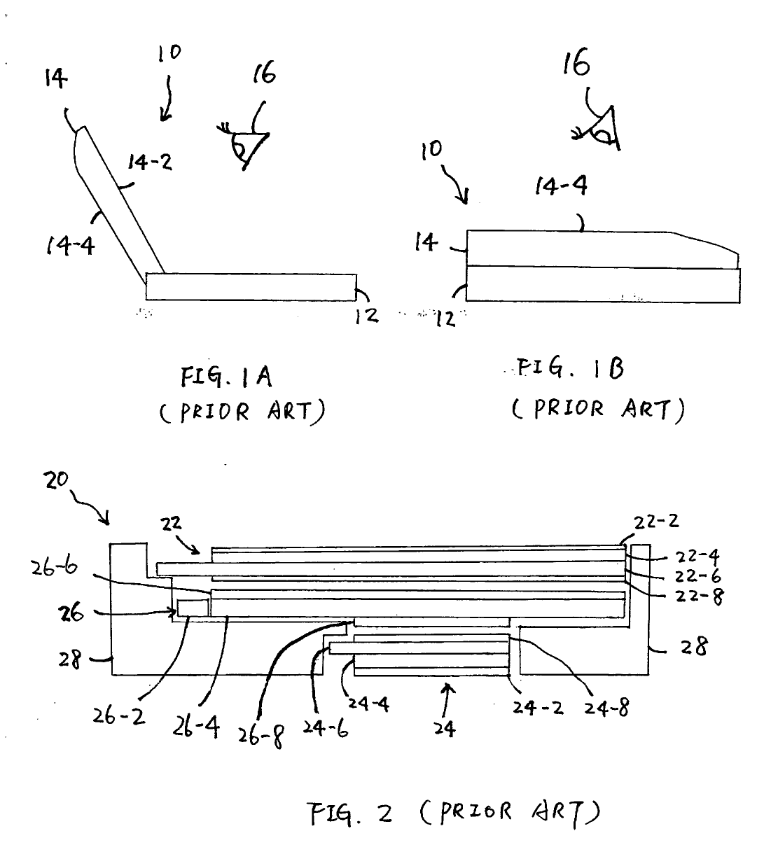

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

FIG. 3 is a cross-sectional view of a display device 50 in accordance with one embodiment of the present invention. Referring to FIG. 3, display device 50 includes a light source 52, a light guide plate 54, a single display panel 56, and a frame 58. Light source 52 may include a lamp (not shown) and a reflector (not shown) surrounding the lamp. In one embodiment according to the invention, light source 52 includes a light emitting diode (“LED”). In another embodiment, light source 52 includes a cold cathode ray tube (“CRT”). In addition to a LED or a cold CRT, display device 50 may use ambient light 72 such as indoor luminescent light or sunlight as a light source. Display device 50 further includes a single integrated circuit (“IC”) 70 corresponding to single display panel 56. IC 70 functions to drive display panel 56 and can be made in the form of a flexible printed circuit (“FPC”).

Light guide plate 54 serves to transmit light 52-2 provided by light source 52 toward display panel 56. In one embodiment, light guide plate 54 is made of acrylic species resin, which is transparent to ambient light 72. Light guide plate 54 includes a first surface 54-2 and a second surface 54-4. In one embodiment according to the invention, first surface 54-2 is formed with a plurality of prisms 54-6 (shown as saw-tooth projections) thereon which constitute a micro-mirror structure to transmit light 52-2 from light source 52 toward display panel 56. Second surface 54-4 may be provided with anti-reflection coating (“ARC”) thereon to secure the transmission of light 52-2 toward display panel 56.

Display panel 56 includes a first polarizer 56-2, a color filter 56-4, a transparent substrate 56-6, and a second polarizer 56-8. A plurality of reflective regions 60 and transmissive regions 62 are formed over transparent substrate 56-6. Reflective regions 60 are separated from each other by transmissive regions 62 such that each of reflective regions 60 is surrounded by transmissive regions 62. Meanwhile, transmissive regions 62 are separated from each other by reflective regions 60 such that each of transmissive regions 60 is surrounded by reflective regions 60. Each of reflective regions 60 is formed with a metal electrode 60-2 thereon to reflect light 52-2 transmitted from light guide plate 54 away from transparent substrate 56-6. In one embodiment according to the invention, metal electrode 60-2 includes a metal material such as aluminum. Each of transmissive regions 62 allows light 52-2 transmitted from light guide plate 54 to pass transparent substrate 56-6. In one embodiment according to the invention, each of transmissive regions 62 is formed with a transparent electrode (not shown) thereon. The transparent electrode can further include an indium tin oxide (“ITO”).

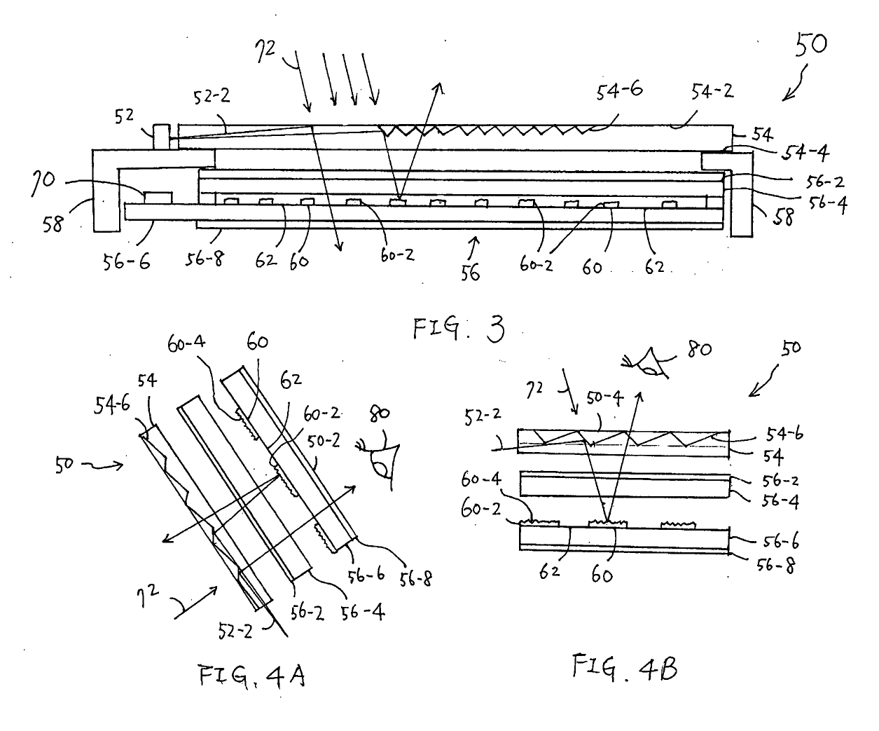

FIGS. 4A and 4B are diagrams illustrating the operation of display device 50 in accordance with one embodiment of the present invention. Referring to FIG. 4A, a part of light 52-2 or ambient light 72 transmitted by light guide plate 54 passes through transmissive regions 62. A user 80 of display device 50 views an image on display at a first viewing face 50-2 of display device 50 from a first direction. In this particular embodiment, single display panel 56 serves to provide the main display function.

Referring to FIG. 4B, a part of light 52-2 or ambient light 72 transmitted by light guide plate 54 is reflected by reflective regions 60. User 80 views an image on display at a second viewing face 50-4 of display device 50 from a second direction substantially opposite to the first direction. In this particular embodiment, single display panel 56 serves to provide sub-display function. Metal electrode 60-2 formed on reflective region 60 further includes a roughened surface 60-4 to enhance reflectivity.

The present invention also provides a method of displaying an image. A single display panel 56 including a first side 56-8 and a second side 56-2 is provided. Both first side 56-8 and second side 56-2 are made of transparent materials. A transparent substrate 56-6 such as a glass substrate is disposed between the first and second sides 56-8 and 56-2. A light source 52 is provided to illuminate single display panel 56. Alternately, ambient light 72 such as indoor luminescent light or sunlight is used for luminescence if conditions permit. A light guide plate 54 made of transparent material such as acrylic species resin is provided to receive light provided by light source 52 or ambient light 72. Light guide plate 54 is provided with a surface 54-2 to transmit light 52-2 toward single display panel 56. A plurality of transmissive regions 62 disposed between light guide plate 54 and transparent substrate 56-6 are provided. A plurality of reflective regions 60 disposed between light guide plate 54 and transparent substrate 56-6 are also provided. Reflective regions 60 are separated from each other by transmissive regions 62. A part of the light transmitted from light guide plate 54 passes through transmissive regions 62 toward first side 56-8 of single display panel 56. Another part of the light transmitted from light guide plate 54 is reflected by reflective regions 60 toward second-side 56-2 of single display panel 56. User 80 of display device 50 may choose to view an image on display from first side 56-8, in which single display panel functions to serve as a main panel. User 80 may alternately choose to view an image on display from second side 56-2, in which single display panel 56 functions to serve as a sub-panel.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A display device comprising:
a first viewing face allowing viewing of a first image on display from a first direction;
a second viewing face allowing viewing of a second image on display from a second direction;
a light source;
a transparent substrate;
a light guide plate receiving light provided by the light source;
a surface of the light guide plate that transmits the light toward the first viewing face; and
a plurality of reflective regions provided over the transparent substrate that reflect the light transmitted from the surface toward the second viewing face.

2. The device of claim 1, each of the reflective regions further comprising a metal electrode formed thereon.

3. The device of claim 1, the light source further comprising a light emitting diode, a cold cathode ray tube and an ambient light.

4. The device of claim 1, the reflective regions being separated from each other by transmissive regions provided over the transparent substrate.

5. The device of claim 1, the light guide plate further comprising a micro-mirror structure formed on the surface.

6. The device of claim 1, the light guide plate further comprising a plurality of prisms formed on the surface.

7. The device of claim 1, the light guide plate further comprising a different surface on which an anti-reflection coating is formed.

8. The device of claim 1, the light guide plate being made of acrylic species resin.

9. A display device comprising:
at least one light source;
a transparent substrate;
a light guide plate receiving light provided by the at least one light source;
a surface of the front light guide plate that transmits the light received from the light source toward the transparent substrate;
a plurality of transmissive regions disposed between the light guide plate and the transparent substrate that allow the light to pass the transparent substrate; and
a plurality of reflective regions disposed between the light guide plate and the transparent substrate that reflect the light toward the light guide plate.

10. The device of claim 9, the at least one light source further comprising a light emitting diode, a cold cathode ray tube and an ambient light.

11. The device of claim 9, the front light guide plate being made of acrylic species resin.

12. The device of claim 9, the transmissive regions further comprising transparent electrodes formed thereon.

13. The device of claim 9, the reflective regions further comprising metal electrodes formed thereon.

14. A display device comprising:
a single display panel including a first side and a second side;
a transparent substrate formed in the single display panel;
a transparent light guide plate receiving light provided by a light source;
a surface of the light guide plate that transmits the light from the light source toward the single display panel;
a plurality of transmissive regions disposed between the transparent light guide plate and the transparent substrate that allow the light to pass the first side of the display panel; and
a plurality of reflective regions separated from each other by the transmission regions that reflect the light toward the second side of the display panel.

15. The device of claim 14 further comprising a single driving circuit driving the single display panel.

16. The device of claim 14, the surface of the transparent light guide plate further comprising a plurality of prisms formed thereon.

17. The device of claim 14, the transparent light guide plate further comprising a different surface on which an anti-reflection coating is formed.

18. A method of displaying an image comprising:
providing a single display panel with a first side and a second side;
providing a transparent substrate disposed between the first and second sides;
providing light from a light source;
providing a transparent light guide plate receiving the light provided by the light source;
providing the transparent light guide plate with a surface;
transmitting the light via the surface toward the display panel;
providing a plurality of transmissive regions disposed between the transparent light guide plate and the transparent substrate;
providing a plurality of reflective regions disposed between the transparent light guide plate and the transparent substrate;
passing the light transmitted from the surface through the transmissive regions through the first side of the display panel; and
reflecting the light transmitted from the surface by the reflective regions toward the second side of the display panel.

19. The method of claim 18 further comprising forming an anti-reflection coating on a different surface of the transparent light guide plate.

20. The method of claim 18 further comprising forming metal electrodes on the reflective regions.
